(19) United States
(12) Patent Application Publication
(10) Pub. No.: US 2009/0143086 A1
(43) Pub. Date: Jun. 4, 2009

(54) Method and apparatus for managing status information in wireless instant messaging system

(75) Inventor: Su-Yeon Jeong, Seoul (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/290,904

(22) Filed: Nov. 5, 2008

(30) Foreign Application Priority Data
Nov. 28, 2007 (KR) 2007-0121926

(51) Int. Cl. H04W 4/12

(52) U.S. Cl. 455/466

(57) ABSTRACT

In a wireless instant messaging system, a first mobile station transmits a PUBLISH message including status information and watcher information. A second mobile station reads the status information published or updated by the first mobile station. A presence server publishes or updates status information mapped to the watcher information included in the PUBLISH message received from the first mobile station and transmits a notification message including the status information to the second mobile station mapped to the watcher information. Other parties (watchers or groups) can read status information desired by a subscriber when the subscriber sets status information for the other parties to read discriminately according to need.

### CROSS-REFERENCE TO RELATED APPLICATION(S) AND CLAIM OF PRIORITY

This application claims the benefit under 35 U.S.C. §119(a) from an application entitled “Method and apparatus for managing status information in wireless instant messaging system” filed on Nov. 28, 2007 and assigned Serial No. 2007-0121926, the entire contents of which are hereby incorporated herein by reference.

### TECHNICAL FIELD OF THE INVENTION

The present invention relates to a method and apparatus for managing status information in a wireless instant messaging system, and more particularly, to a method and apparatus for managing status information that can maximize privacy performance by making it possible for other parties (watchers or groups) to read subscriber-desired status information according to need when a subscriber of the wireless instant messaging system sets status information discriminately on the basis of the other party.

### BACKGROUND OF THE INVENTION

Instant messaging was introduced in the 1990s and has rapidly developed. It is expected to continue developing along with future improvements in e-mail and telephone technologies in global communication networks.

However, many networks of current instant messaging vendors lack interoperability. This generates the drawbacks of chat links and connections between users of different instant messaging networks being unidentifiable, and newly developed progressive services being available only to subscribers on a closed network rather than to all users.

For the security and interoperability of instant messaging, the instant messaging and presence protocol (IMPP) working group of the internet engineering task force (IETF) is currently working on standardization.

The IMPP working group has proposed protocols such as instant messaging extensible protocol (IMXP), presence and instant messaging (PIM), session initiation protocol (SIP) for instant messaging and presence leveraging extensions (SIMPLE), and the like.

On the other hand, parties concerned with IMUnified (a coalition of companies aimed at developing open standards for IM) have organized a presence and availability management (PAM) forum. Instant messaging providers are developing presence-based applications working together with other companies to construct a common application program interface (API) capable of developing compatible products.

With the ongoing development of mobile communication technology and the increasing number of subscribers, the open mobile architecture initiative (OMAI) forum group and the wireless architecture protocol (WAP) forum group have been consolidated to form the open mobile alliance (OMA)—a forum for verifying technical standard development and interoperability to globally activate mobile data service. The OMA aims to ensure interoperability between devices, regions, service providers, operators, and networks, in line with the demands of consumers on mobile service enablers.

The OMA makes it possible for mobile stations of a mobile communication system to receive a presence service as well as an instant messaging service through wireless Internet.

That is, the mobile station may receive the presence service through OMA instant messaging and presence service (IMPS) and OMA SIMPLE.

The presence service is a service for properly providing presence information, which includes information on the communication ability and willingness, present status, and so forth, of a user or a group to other parties or objects interested therein through a set of devices.

Accordingly, a user may access a presence server for providing the presence service and update his or her status information, or read status information of another party.

In general, a user (publisher) may access the presence server through a wireless Internet network using a mobile station to publish or update the presence information such as present status information (presence values) and the like, and a user (watcher) interested in the present status of the publisher may access the presence server to read the presence information of the other party by identifying the present status of the publisher.

Since a publisher only publishes one present status in the existing presence service, a watcher individual or watchers belonging to a group may read only that present status of the publisher.

Users of the present instant messaging service may require privacy information at a very high level.

That is, user privacy, which is an important consideration when it comes to the presence service, may not reach a privacy level desired by users. For example, a user may desire to show a first status as the present status (for example, busy) to a specific watcher or watchers belonging to a specific group, and show a second status (for example, open) to watchers other than the specific watcher or the watchers belonging to the specific group. However, since information of only one status may be published, the user must show the first status to all watchers by publishing the first status to the presence server.

### SUMMARY OF THE INVENTION

To address the above-discussed deficiencies of the prior art, it is a primary object to provide a method and apparatus for managing status information in a wireless instant messaging system that make it possible for a user (publisher) to publish or update his or her presence information (for example, present status information) discriminately on the basis of watcher or group in the instant messaging system supporting a presence service.

According to an aspect of the present invention, there is provided a wireless instant messaging system including: a first mobile station that transmits a PUBLISH message including status information and watcher information; a second mobile station that reads the status information published or updated by the first mobile station; and a presence server that publishes or updates status information mapped to the watcher information included in the PUBLISH message received from the first mobile station, and transmits a notification message including the status information to the second mobile station mapped to the watcher information.

The presence server may include: a message processor that extracts the status information and the watcher information from the PUBLISH message received from the first mobile station and generates and transmits the notification message to the second mobile station; and a status information manager that publishes watcher information discriminately according to publisher and publishes or updates the status information in presence information of the first mobile station mapped to the watcher information included in the PUBLISH message.

The message processor may generate and transmit the notification message when a presence request message is received from the second mobile station, and may generate and transmit an information response message including status information published or updated discriminately on the basis of watcher or group when an information request message is received from the first mobile station.

The status information manager may provide the message processor with the status information of the first mobile station published or updated discriminately according to watcher or group.

When a presence service based on OMA IMPS is provided, the first mobile station may set status information selected by a publisher in the PUBLISH message, set the watcher information in an additional watcher setting field, and transmit the PUBLISH message to the presence server.

When an information request message is received from the first mobile station, the presence server may transmit an information response message in which status information published or updated discriminately on the basis of watcher or group is written in a plurality of status information fields added to the notification message.

When a presence service based on OMA SIMPLE is provided, the first mobile station may newly define a content type of the PUBLISH message, set status information selected by a publisher in a status field, and set the watcher information in an additional tuple corresponding to the watcher setting field, and transmit the PUBLISH message to the presence server.

When an information request message is received from the first mobile station, the presence server may transmit an information response message including status information published or updated discriminately on the basis of watcher or group in an extension event field added to the notification message.

When the PUBLISH message is received, the presence server may publish or update the status information mapped to the watcher information, determine whether a watcher requesting to read the status information is approved, and transmit notification information including the published or updated status information to the second mobile station mapped to the watcher information.

The wireless instant messaging system may further include: a database that publishes watcher information discriminately according to publisher and publishes status information of a publisher discriminately according to watcher, wherein when a SIMPLE-based presence service is provided, the presence server may set status information discriminately according to watcher by adding a watcher list and an extension field in which watcher-specific status information is set to the database.

The watcher information may be one of mobile station identification information, watcher identification information, and group identification information.

According to another aspect of the present invention, there is provided a method for managing status information in a wireless instant messaging system including a plurality of mobile stations and a presence server, including the steps of: publishing, by the presence server, watcher information discriminately according to publisher; publishing or updating status information mapped to watcher information when a PUBLISH message including the status information and the watcher information is received from a first mobile station; transmitting a notification message including the published or updated status information to a second mobile station mapped to the watcher information; and generating and transmitting a notification message including the status information mapped to the second mobile station when a presence request message is received from the second mobile station.

The method may further include the step of: transmitting an information response message including status information published or updated discriminately on the basis of watcher or group when the presence server receives an information request message from the first mobile station.

The step of transmitting the information response message may include the steps of: checking, by the presence server, a system for supporting a presence service; when the presence service is based on OMA IMPS, generating the information response message by writing the status information published or updated discriminately on the basis of watcher or group in a plurality of status information fields added to the notification message; and when the presence service is based on OMA SIMPLE, generating the information response message including the status information published or updated discriminately on the basis of watcher or group by adding an extension event field to a format of the notification message.

The method may further include the steps of: checking, by the first mobile station, a system for supporting a presence service; when the presence service is based on OMA IMPS, generating the PUBLISH message including status information selected by a publisher and the watcher information set in an additional watcher setting field; and when the presence service is based on OMA SIMPLE, generating the PUBLISH message by newly defining a content type of the PUBLISH message, setting the status information selected by the publisher in a status field, and setting the watcher information in an additional tuple corresponding to a watcher setting field.

The step of transmitting the notification message to the second mobile station may include the steps of: determining whether a corresponding watcher for which the status information is published or updated is approved; and transmitting the notification message including the status information when the corresponding watcher is approved.

The step of publishing or updating the status information mapped to the watcher information may include the steps of: when an OMA SIMPLE-based presence service is provided, adding, by the presence server, an extension field to a resource list server (RLS) and publishing or updating status information discriminately according to watcher or group.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a wireless instant messaging system according to an exemplary embodiment of the present invention;

FIG. 2 is a block diagram illustrating a presence server according to an exemplary embodiment of the present invention;

FIG. 3 is a flowchart illustrating a status information management method of the wireless instant messaging system according to an exemplary embodiment of the present invention;

FIG. 4 is a message flow diagram for providing a presence service applied to the present invention;

FIG. 5A illustrates a format of an IMPS-based PUBLISH message according to an exemplary embodiment of the present invention;

FIG. 5B illustrates a format of an IMPS-based notification message according to an exemplary embodiment of the present invention;

FIG. 5C illustrates a format of an IMPS-based information request message according to an exemplary embodiment of the present invention;

FIG. 5D illustrates a format of an IMPS-based information response message according to an exemplary embodiment of the present invention;

FIG. 6A illustrates a format of a SIMPLE-based PUBLISH message according to an exemplary embodiment of the present invention;

FIG. 6B illustrates a format of a SIMPLE-based notification message according to an exemplary embodiment of the present invention;

FIG. 6C illustrates a format of a SIMPLE-based information request message according to an exemplary embodiment of the present invention; and

FIG. 6D illustrates a format of a SIMPLE-based information response message according to an exemplary embodiment of the present invention.

### DETAILED DESCRIPTION OF THE INVENTION

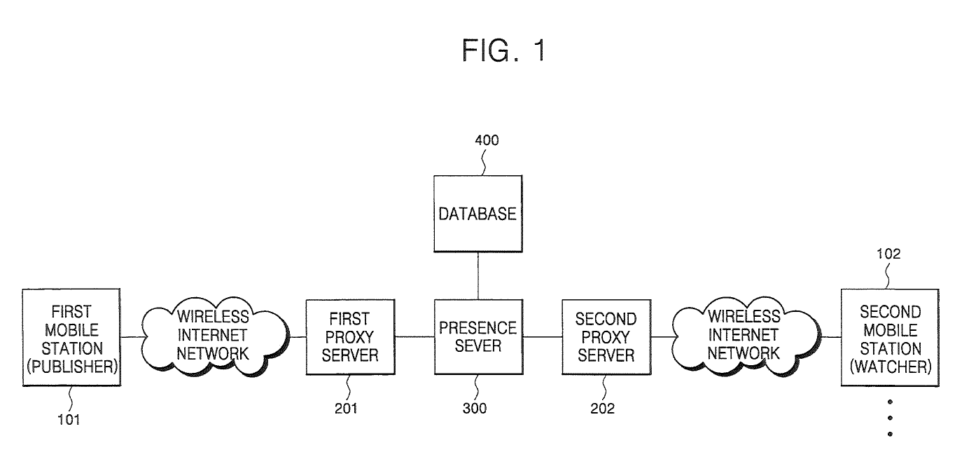

FIGS. 1 through 6D, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

A method and apparatus for managing status information in a wireless instant messaging system according to an exemplary embodiment of the present invention will now be described more fully hereinafter with reference to the accompanying drawings. A message exchange between a publisher and a watcher takes place between mobile stations of the publisher and the watcher.

FIG. 1 is a block diagram illustrating a wireless instant messaging system according to an exemplary embodiment of the present invention.

Referring to FIG. 1, the wireless instant messaging system includes a plurality of mobile stations 101 and 102, a plurality of proxy servers 201 and 202, a presence server 300, and a database 400.

In the-following description of the present invention, it is assumed that the first mobile station 101 belongs to a publisher for publishing or updating presence information (that is, status information) and the second mobile station 102 belongs to a watcher interested in the status information of the publisher of the first mobile station 101.

The first and second proxy servers 201 and 202 process a relay function to enable the mobile stations 101 and 102 to access an Internet network through a wireless Internet network (or mobile communication network). Through the first and second proxy servers 201 and 202, a message can be exchanged between the first mobile station 101 and the presence server 300 such that the status information is published or updated, and a message can be exchanged between the second mobile station 102 and the presence server 300 such that the status information of the first mobile station 101 is read.

The presence server 300 manages subscriber information of subscribers joining an instant messaging service in the form of a list or group, and publishes or manages subscriber presence information received from each subscriber (i.e., the mobile stations 101 and 102).

That is, the presence server 300 publishes or manages the presence information set on a subscriber-by-subscriber basis (for example, the status information) in the database 400, and delivers the status information of a corresponding subscriber (publisher) to a watcher when there is a request from the watcher.

The presence server 300 can publish or manage the status information of the subscribers (that is, the publishers) discriminately according to watcher or group, and can perform setting operations discriminately according to watcher or group, according to the status information and the watcher information included in a PUBLISH message received from the publisher.

At this time, the watcher information can be identification information of the second mobile station of the watcher, watcher identification information, or group identification information.

Table 1 shows an example in which the presence server 300 manages the status information of the publisher.

TABLE 1

| Watcher | | Group | |
|---|---|---|---|
| Identification | | Identification Info | |
| Info (for example, | | (for example, | |
| name) | Status Info | group name) | Status Info |
| ZZZ | First Status | Friend | Second Status |
| XXX | Second Status | Company | Second Status |
| CCC | Second Status | Sibling | First Status |
| — | — | — | — |

As shown in Table 1, the presence server 300 can publish or update watcher information and status information by extracting the status information and the watcher information included in the PUBLISH message received from the first mobile station 101.

For example, as shown in Table 1, the presence server 300 can set the status information for only the ‘ZZZ’ watcher of registered watchers and the ‘Sibling’ group of registered groups to the first status, and the status information for other watchers to the second status.

Accordingly, when a presence request message is received from the ‘ZZZ’ watcher and watchers belonging to the ‘Sibling’ group or the status information is published or updated, the presence server 300 transmits a notification message in which the status information of the publisher is set to the first status. When a presence request message is received from other watchers, the presence server 300 transmits a notification message in which the status information of the publisher is set to the second status.

On the other hand, the publisher generates the PUBLISH message including the status information and the watcher information through the first mobile station 101 and transmits the generated message to the presence server 300.

When the PUBLISH message is received from the first mobile station 101, the presence server 300 extracts the status information and the watcher information and publishes or updates the extracted status information in the presence information mapped to the corresponding watcher information.

When the presence request message is received from the second mobile station 102 of the watcher or the status information is published or updated, the presence server 300 provides the mobile station 102 of the watcher with the corresponding published or updated status information through a notification message.

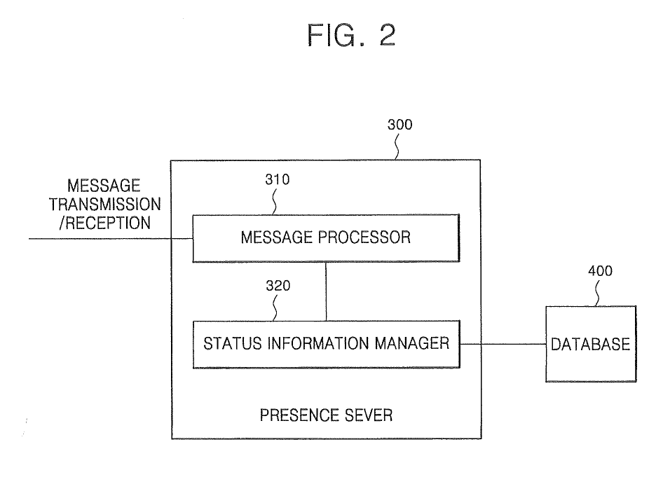

FIG. 2 is a block diagram illustrating the presence server according to an exemplary embodiment of the present invention.

Referring to FIG. 2, the presence server according to the exemplary embodiment of the present invention includes a message processor 310 for processing a message exchanged with the mobile stations 101 and 102, and a status information manager 320 for managing status information of the publisher published in the database 400.

When a PUBLISH message is received from the first mobile station 101 of the publisher, the message processor 310 extracts watcher information and status information from the PUBLISH message and provides the status information manager 320 with the extracted information.

When the status information of the publisher is published or updated, the message processor 310 generates a notification message including the status information of the publisher and transmits the generated message to the second mobile station 102 of the corresponding watcher.

When a presence request message is received from the watcher, the message processor 310 transmits a notification message including the status information of the publisher mapped corresponding to the watcher. When an information request message is received from the publisher, the message processor 310 transmits an information response message including the status information for a registered watcher or group published in the database 400.

A format of a message to be processed by the message processor 310 can be generated and processed on the basis of OMA IMPS and OMA SIMPLE. The message format will be described in detail below.

The status information manager 320 publishes watcher information (of watchers or groups) according to publisher, and performs a management operation by publishing or updating the status information of the publisher based on the status information and the watcher information included in the PUBLISH message received through the message processor 310 according to watcher or group.

When the information request message is received through the message processor 310, the status information manager 320 provides the message processor 310 with watcher-specific or group-specific status information published in the database 400. The message processor 310 can generate and transmit an information response message.

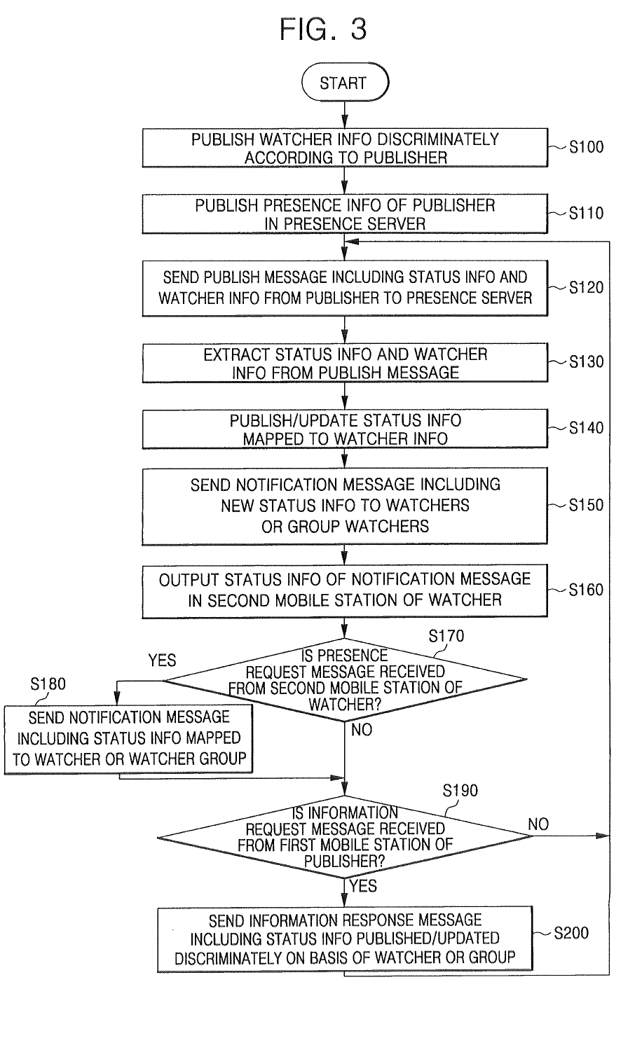

FIG. 3 is a flowchart illustrating a status information management method of the wireless instant messaging system according to an exemplary embodiment of the present invention.

Referring to FIG. 3, the presence server 300 publishes watcher information discriminately based on publisher (S100).

The presence server 300 collects and publishes presence information of a publisher (for example, status information) (S110).

When the publisher desires to show status information thereof to a specific watcher or watchers belonging to a group, a PUBLISH message including status information and watcher information is transmitted to the presence server 300 through the first mobile station 101 (S120). At this time, the watcher information can be mobile station identification information of a watcher, watcher identification information, or group identification information.

The presence server 300 extracts the status information and the watcher information included in the PUBLISH message received from the publisher (S130).

The presence server 300 publishes or updates status information mapped to the watcher information extracted from the PUBLISH message (S140).

As shown in Table 1, the presence server 300 can perform a publish or update operation such that the status information to be shown to a watcher or watchers belonging to the group selected by the publisher is different from that to be shown to other watchers.

When the PUBLISH message is received from the publisher and the status information is published or updated, the presence server 300 transmits a notification message including newly published or updated status information to the watcher or watchers belonging to the group (S150).

The watcher outputs the status information included in the notification message received from the presence server 300 through a display means (S160).

That is, the second mobile station 102 of the watcher extracts the status information included in the notification message received from the presence server 300 and outputs the extracted status information as the present status of the publisher.

On the other hand, the presence server 300 determines whether a presence request message is received from the second mobile station 102 of the watcher (S170). When the presence request message is received, the presence server 300 transmits a notification message including status information mapped to a corresponding watcher or a group to which the corresponding watcher belongs (S180).

The publisher publishes or updates status information discriminately according to watcher. When reading the present status of the publisher shown to the watchers, the publisher transmits an information request message to the presence server 300.

That is, the presence server 300 determines whether the information request message is received from the first mobile station 101 of the publisher (S190). When the information request message is received, the presence server 300 provides the first mobile station 101 with an information response message including status information of the database 400 published or updated discriminately according to watcher or group (S200).

The first mobile station 101 reads watcher-specific or group-specific status information from the information response message and outputs the read status information to the publisher.

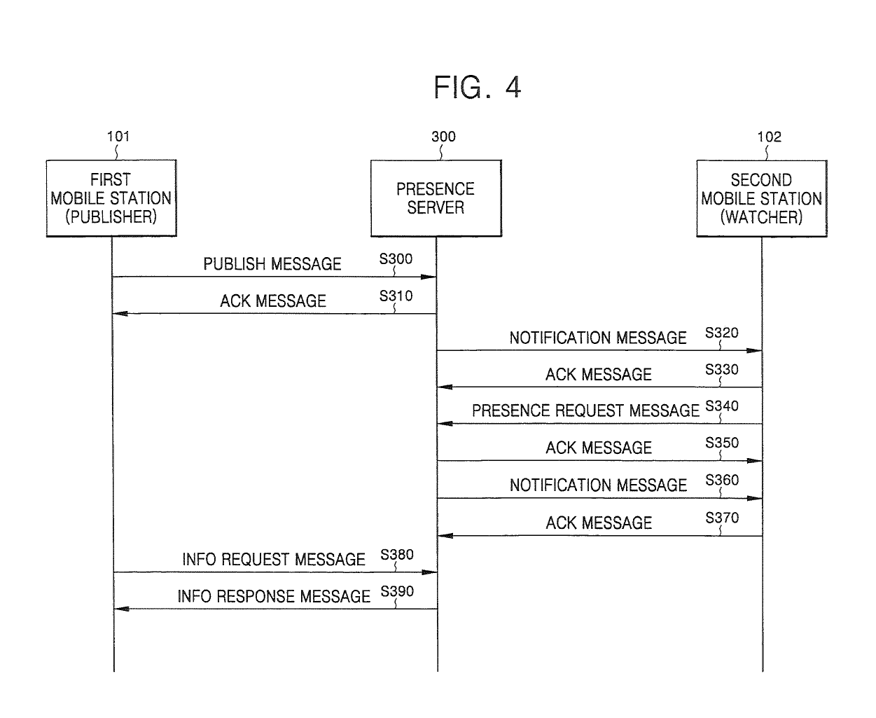

FIG. 4 is a message flow diagram for providing a presence service applied to the present invention.

Referring to FIG. 4, the first mobile station 101 of the publisher transmits a PUBLISH message including status information and watcher information to the presence server 300 so as to publish or update the status information (S300).

The presence server 300 extracts the status information and the watcher information included in the PUBLISH message, updates the presence information (that is, the status information of the publisher) and transmits an acknowledgement (ACK) message to the first mobile station 101 (S310).

Then, when the status information of the publisher is published or updated, the presence server 300 transmits a notification message including the published or updated status information to the second mobile station 102 of the watcher mapped to the watcher information included in the PUBLISH message (S320).

The second mobile station 102 outputs the present status of the publisher in the status information included in the received notification message and transmits an ACK message to the presence server 300 (S330).

When desiring to read the present status of the publisher who is a target of interest, the watcher transmits a presence request message to the presence server 300 through the second mobile station 102 (S340). When the presence request message is received, the presence server 300 transmits an ACK message to the second mobile station 102 (S350).

When the presence request message is received from the second mobile station 102, the presence server 300 transmits a notification message including status information for a corresponding watcher updated by the publisher to the second mobile station 102 (S360).

When the notification message is received, the second mobile station 102 transmits an ACK message to the presence server 300 (S370).

At this time, the presence server 300 determines whether the watcher requesting to read the status information published or updated by the publisher is an approved watcher on the basis of the presence information. In the case of an approved watcher, the presence server 300 transmits the notification message including the status information of the publisher. That is, the presence server 300 determines whether the watcher requesting to read the status information of the publisher is approved (watcher filtering) and transmits the status information of the publisher only when the watcher is approved.

When there is a request of the publisher, the first mobile station 101 transmits an information request message for reading currently updated watcher-specific or group-specific status information to the presence server 300 (S380). When the information request message is received, the presence server 300 transmits an information response message including status information of the database 400 published or updated discriminately according to watcher or group to the first mobile station 101 (S390).

The ACK messages transmitted in the above-mentioned steps S310, S330, S350, and S370 are used to notify a transmitting side that a receiving side has completed an operation for normally receiving the message.

According to the exemplary embodiment of the present invention, the wireless instant messaging system can provide a presence service based on the OMA IMPS and OMA SIMPLE.

An OMA IMPS-based message can be created on the basis of wireless binary XML (WBXML) or on the basis of text similar to that of SIP. Since the message format is well known, a detailed description thereof is omitted.

In the following description, the case where status information is published or updated discriminately according to watcher will be described. This is the same as the case where status information is published or updated discriminately based on group.

First, a message format of an IMPS-based presence service will be described.

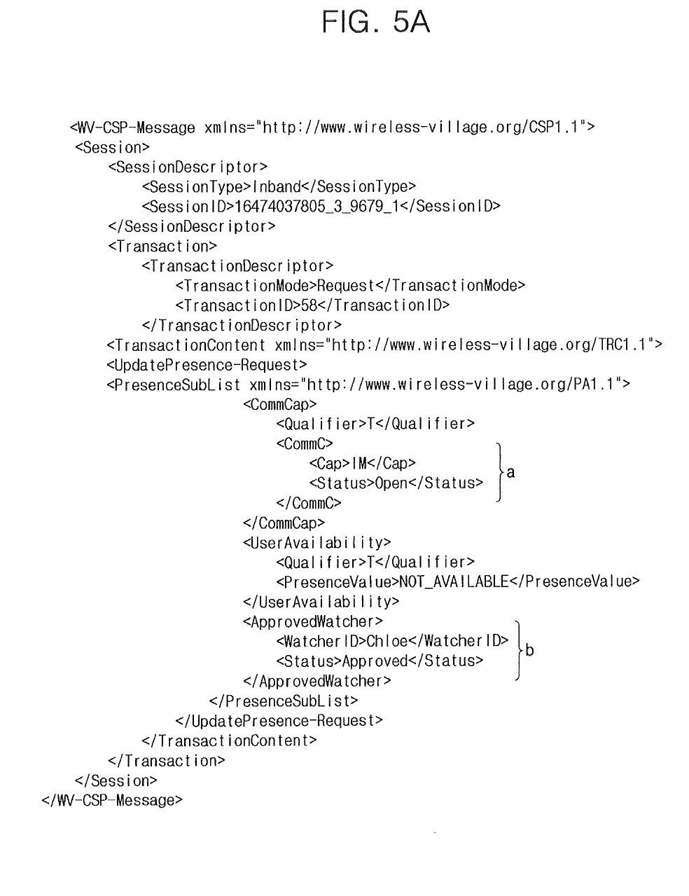

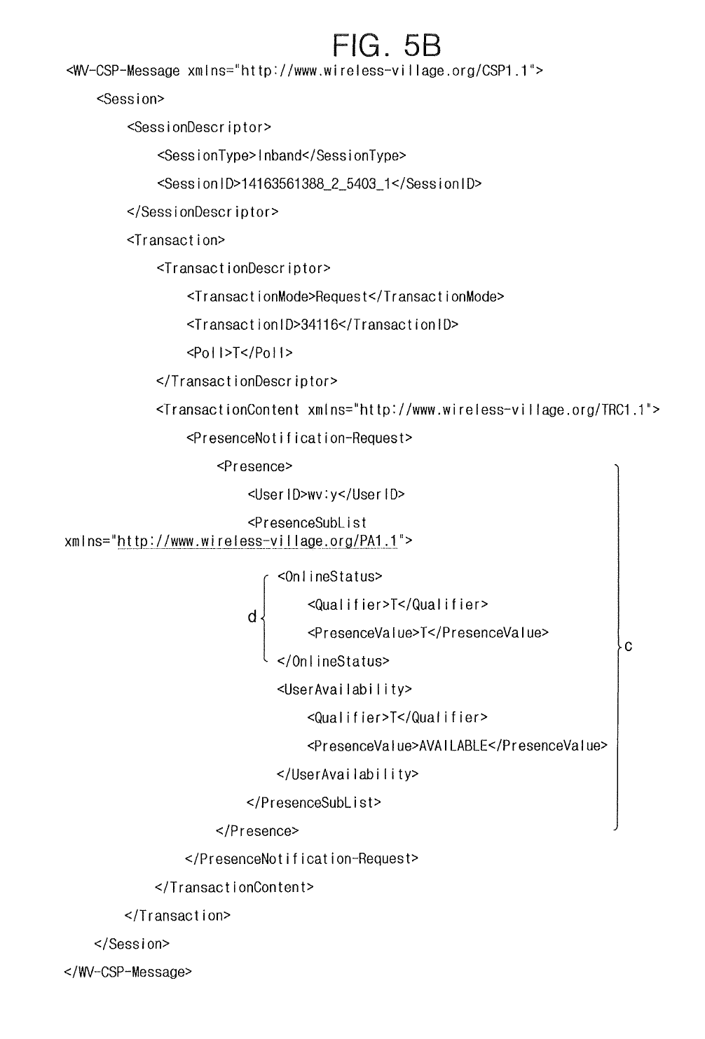

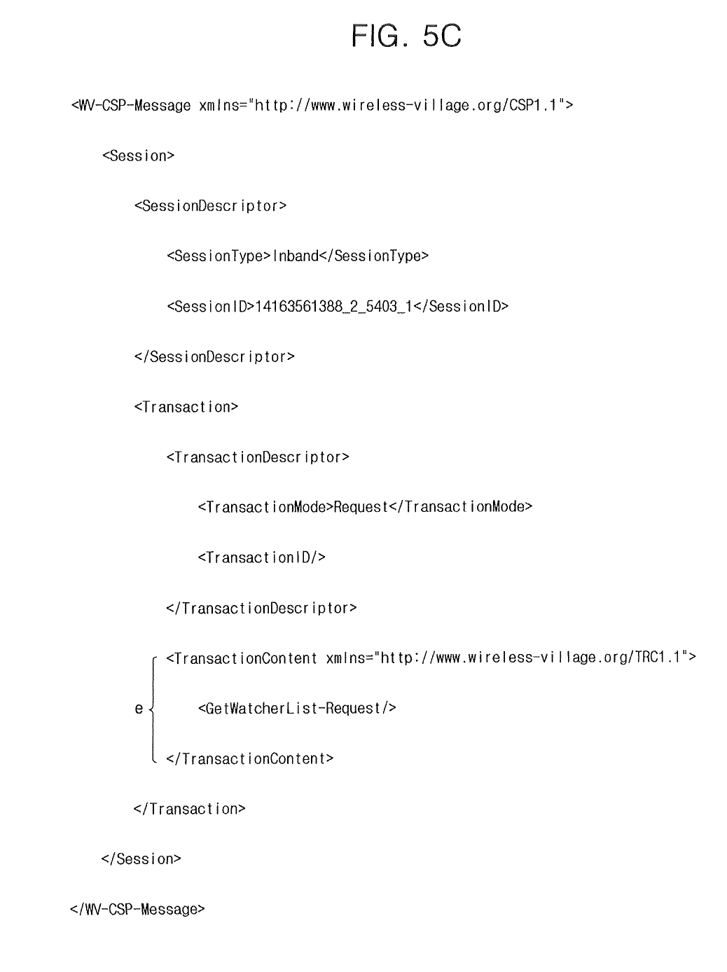

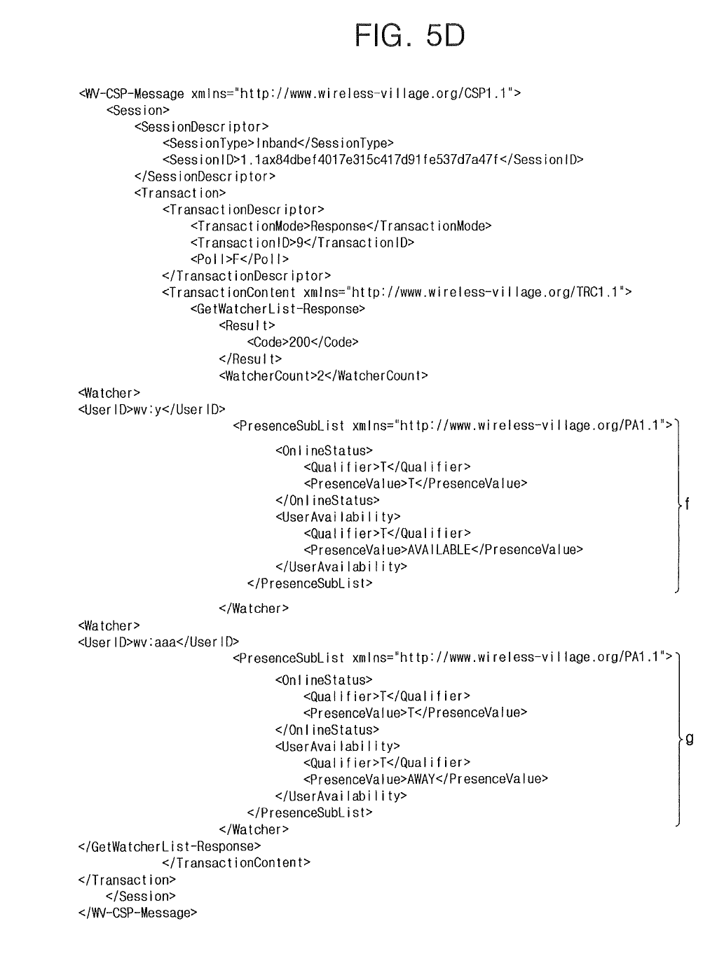

FIG. 5A illustrates a format of an IMPS-based PUBLISH message.

Referring to FIG. 5A, the PUBLISH message format includes watcher identification information (watcher information) and status information so as to publish or update watcher-specific status information.

Referring to the format of the PUBLISH message illustrated in FIG. 5A, the publisher of the first mobile station 101 sets present status information to ‘open’ status (second status) to be shown to a ‘chloe’ watcher.

In the PUBLISH message, the present status of the first mobile station 101 is set to ‘open’ in a status field a, and ‘chloe’ being a specific watcher capable of reading the status information of the publisher is set to be approved in a watcher setting field b, such that the ‘open’ can be read as the status information.

The status information manager 320 of the presence server 300 sets the present status of the publisher, mapped to the watcher to which watcher identification information of ‘chloe’ is assigned, to the ‘open’ status, and provides the second mobile station 102 of ‘chloe’ with a notification message in which the status information of the publisher is set to the ‘open’ status.

Specifically, the first mobile station 101 can set the status of the publisher to be shown to a specific watcher by providing the presence server 300 with a PUBLISH message in which the watcher information (‘chloe’) of the specific watcher and an indication that the specific watcher is approved are set in the watcher setting field b, and the present status (‘open’ status) to be shown to the specific watcher is set in the status field a.

As described above, the publisher can publish or update status information discriminately according to watcher or group by adding the watcher setting field b in which the watcher or group identification information can be written to the PUBLISH message format.

FIG. 5B illustrates a format of an IMPS-based notification message. As illustrated in FIG. 5B, the presence server 300 can transmit a notification message including presence information of a publisher (that is, status information) to the second mobile station 102 of a watcher.

That is, the presence server 300 inserts the presence information c of the publisher into the notification message and transmits the notification message. The presence information includes the status information d of the publisher.

At this time, when watcher-specific or group-specific status information is published or updated, the presence server 300 determines whether a corresponding watcher or watchers belonging to a group are approved. When the watcher(s) is/are approved, the notification message including the published or updated status information is transmitted.

FIG. 5C illustrates a format of an IMPS-based information request message. As illustrated in FIG. 5C, the publisher can transmit an information request message for requesting a watcher list to the presence server 300.

The publisher transmits the information request message in which a request of a list of registered watchers or watchers belonging to a group (for example, GetWatcherList-Request as indicated by e) is written to the presence server 300 through the first mobile station 101.

FIG. 5D illustrates a format of an IMPS-based information response message. As illustrated in FIG. 5D, the presence server 300 transmits an information response message including status information currently published or updated discriminately according to watcher or group to the first mobile station 101 of the publisher.

The information response message illustrated in FIG. 5D is transmitted to the publisher through a plurality of status information fields in which status information to be viewed by a ‘wv:y’ watcher is set to ‘AVAILABLE’ as indicated by f, and status information to be viewed by a ‘wv:aaa’ watcher is set to ‘AWAY’ as indicated by g.

That is, the presence server 300 generates the information response message by adding the plurality of status information fields to a notification message and writing published status information discriminately according to watcher or group. The first mobile station 101 reads watcher-specific or group-specific watcher information and status information mapped to corresponding watcher information and outputs the read information to the publisher.

On the other hand, a message will be described when a SIMPLE-based presence service is provided.

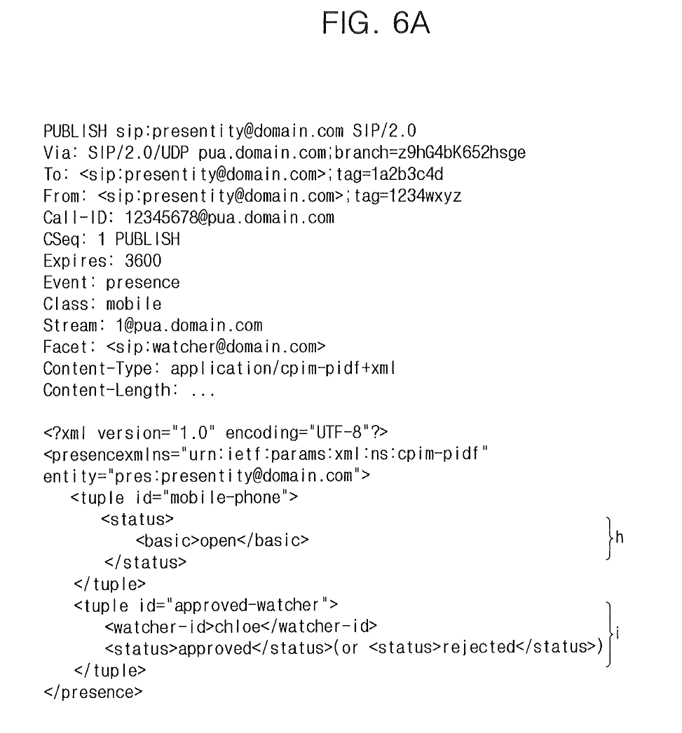

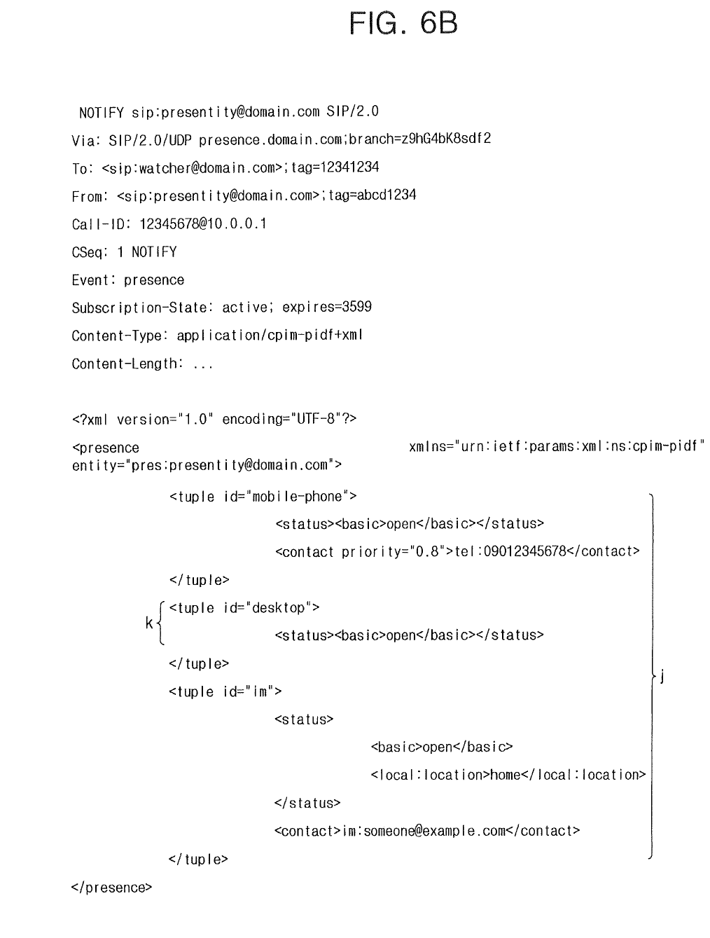

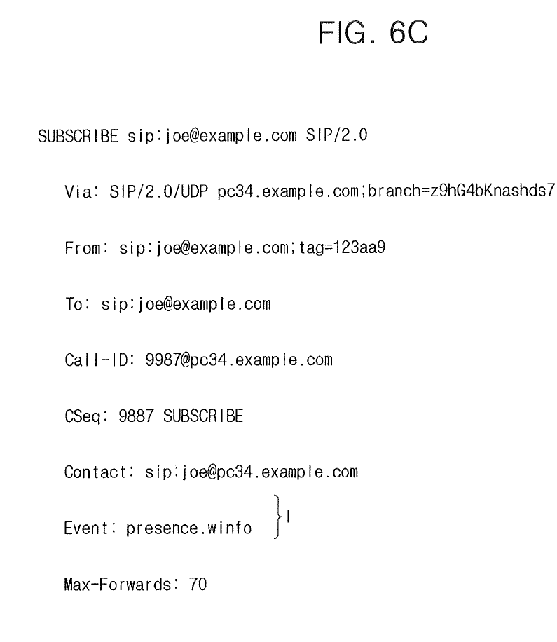

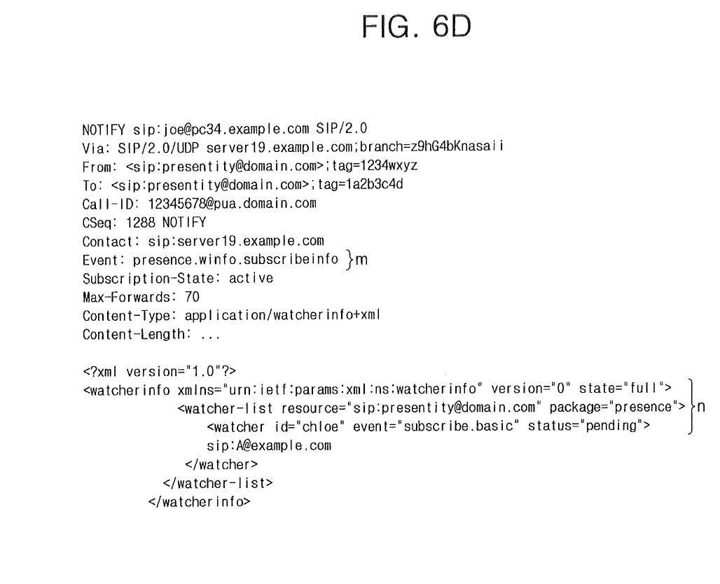

FIG. 6A illustrates a format of a SIMPLE-based PUBLISH message. Referring to FIG. 6A, the PUBLISH message format includes watcher identification information (watcher information) and status information so as to publish or update watcher-specific status information.

Referring to the message format illustrated in FIG. 6A, the publisher of the first mobile station 101 sets his or her present status information such that the ‘open’ status (second status) is shown to the ‘chloe’ watcher.

The present status of the mobile station 101 is set to the ‘open’ status in a status field h and information indicating that ‘chloe’ is approved to read the present status is set in a watcher setting field i.

Thus, status information mapped to a specific watcher or group can be set discriminately by adding a tuple i for setting watcher or group identification information to an existing presence information data format (PIDF). For this, a content type of a PUBLISH message can be newly defined.

The first mobile station 101 sets specific watcher information in the watcher setting field i added to the PUBLISH message, sets status information to be shown to a corresponding watcher in the status field h, and transmits the PUBLISH message to the presence server 300, such that the presence server 300 discriminately publishes or updates status information of the publisher to be shown to the specific watcher.

FIG. 6B illustrates a format of a SIMPLE-based notification message. As shown in FIG. 6B, the presence server 300 can transmit the notification message including presence information j (that is, status information k (for example, ‘open’)) to the second mobile station 102.

The notification message includes the presence information j of the publisher and is transmitted to the watcher (watcher@domain.com). The presence information includes the status information k of the publisher.

The presence server 300 transmits a notification message in which presence information including status information published or updated discriminately on the basis of watcher or group is written to the second mobile station 102. The second mobile station 102 identifies the status information of the presence information included in the notification message and outputs the identified status information to the watcher.

FIG. 6C illustrates a format of a SIMPLE-based information request message. As illustrated in FIG. 6C, the publisher can transmit an information request message for requesting a watcher list (presence.winfo) to the presence server 300.

The publisher transmits an information request message in which a request for a list of registered watchers or group watchers (presence.winfo) is written as indicated by l, to the presence server 300 through the first mobile station 101.

FIG. 6D illustrates a format of a SIMPLE-based information response message. As illustrated in FIG. 6D, the presence server 300 transmits an information response message including status information currently published or updated discriminately according to watcher or group to the first mobile station 101.

When a SIMPLE-based presence service is provided, the status information manager 320 of the presence server 300 publishes or updates a watcher list and watcher-specific status information in a resource list server (RLS) corresponding to the database 400, adds an extension field for setting status information discriminately according to watcher, and publishes or updates status information received from a PUBLISH message.

The presence server 300 transmits an information response message in which the extension event (presence.winfo.subscribeinfo) m is added to the format of the notification message to the publisher such that the publisher can read status information set according to watcher. In the information response message, status information (‘pending’) set discriminately according to watcher or group is written as indicated by m.

That is, the presence server 300 generates an extension response message by adding the extension event m to the notification message. In the extension response message, watcher information and status information n of the publisher set discriminately in watcher-specific extension fields in the presence information of the publisher are written to be shown to corresponding watchers. Accordingly, the first mobile station 101 identifies the watcher information and the status information included in the extension response message and outputs the identified information to the publisher, such that the publisher can read his or her present status to be shown to the watchers.

On the other hand, when the watcher-specific or group-specific status information is published or updated, the presence server 300 retrieves an approved watcher from a watcher list and transmits a notification message including published or updated status information to a corresponding watcher.

The present invention can maximize privacy when a subscriber of a wireless instant messaging system sets status information discriminately on the basis of the other party (watcher or group) according to need.

Since status information is published or updated discriminately according to the other party, the subscriber can read the status information currently set for other parties according to need and can change the status information capable of being read by other parties designated by the subscriber.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A wireless instant messaging system comprising:
a first mobile station that transmits a PUBLISH message including a status information and a watcher information;
a second mobile station associated with the watcher information, the second mobile station reads the status information published or updated by the first mobile station; and
a presence server that publishes or updates status information associated with the watcher information included in the PUBLISH message received from the first mobile station, and transmits a notification message including the status information to the second mobile station.

2. The wireless instant messaging system of claim 1, wherein the presence server includes:
a message processor that extracts the status information and the watcher information from the PUBLISH message received from the first mobile station and generates and transmits the notification message to the second mobile station; and
a status information manager that publishes watcher information discriminately according to publisher and publishes or updates the status information in a presence information of the first mobile station associated with the watcher information included in the PUBLISH message.

3. The wireless instant messaging system of claim 2, wherein the message processor generates and transmits the notification message when a presence request message is received from the second mobile station, and generates and transmits an information response message including a status information published or updated discriminately on the basis of watcher or group when an information request message is received from the first mobile station.

4. The wireless instant messaging system of claim 3, wherein the status information manager provides the message processor with the status information of the first mobile station published or updated discriminately according to watcher or group.

5. The wireless instant messaging system of claim 1, wherein when a presence service based on open mobile alliance (OMA) instant messaging and presence service (IMPS) is provided, the first mobile station sets the status information selected by a publisher in the PUBLISH message, sets the watcher information in an additional watcher setting field, and transmits the PUBLISH message to the presence server.

6. The wireless instant messaging system of claim 5, wherein when an information request message is received from the first mobile station, the presence server transmits an information response message in which the status information published or updated discriminately on the basis of watcher or group is written in a plurality of status information fields added to the notification message.

7. The wireless instant messaging system of claim 1, wherein when a presence service based on OMA session initiation protocol for instant messaging and presence leveraging extensions (SIMPLE) is provided, the first mobile station newly defines a content type of the PUBLISH message, sets the status information selected by a publisher in a status field, sets the watcher information in an additional tuple corresponding to a watcher setting field, and transmits the PUBLISH message to the presence server.

8. The wireless instant messaging system of claim 7, wherein when an information request message is received from the first mobile station, the presence server transmits an information response message including the status information published or updated discriminately on the basis of watcher or group in an extension event field added to the notification message.

9. The wireless instant messaging system of claim 1, wherein when the PUBLISH message is received, the presence server publishes or updates the status information corresponding to the watcher information, determines whether a watcher requesting to read the status information is approved, and transmits a notification information including the published or updated status information to the second mobile station.

10. The wireless instant messaging system of claim 1, further comprising:
a database that publishes watcher information discriminately according to publisher and publishes status information of a publisher discriminately according to watcher,
wherein when a SIMPLE-based presence service is provided, the presence server sets the status information discriminately according to watcher by adding a watcher list and an extension field in which a watcher-specific status information is set according to the database.

11. The wireless instant messaging system of claim 1, wherein the watcher information is selected from the group consisting of a mobile station identification information, a watcher identification information, and a group identification information.

12. A method for managing status information in a wireless instant messaging system including a plurality of mobile stations and a presence server, comprising the steps of:
publishing, by the presence server, a watcher information discriminately according to publisher;
publishing or updating a status information corresponding to the watcher information when a PUBLISH message including the status information and the watcher information is received from a first mobile station;
transmitting a notification message including the published or updated status information to a second mobile station associated with the watcher information; and
generating and transmitting a notification message including the status information associated with the second mobile station when a presence request message is received from the second mobile station.

13. The method of claim 12, further comprising the step of:
transmitting an information response message including the status information published or updated discriminately on the basis of watcher or group when the presence server receives an information request message from the first mobile station.

14. The method of claim 13, wherein the step of transmitting the information response message includes the steps of:
checking, by the presence server, a system for supporting a presence service;
when the presence service is based on OMA IMPS, generating a information response message by writing the status information published or updated discriminately on the basis of watcher or group in a plurality of status information fields added to the notification message; and
when the presence service is based on OMA SIMPLE, generating an information response message including the status information published or updated discriminately on the basis of watcher or group by adding an extension event field to a format of the notification message.

15. The method of claim 12, further comprising the steps of:
checking, by the first mobile station, a system for supporting a presence service;
when the presence service is based on OMA IMPS, generating the PUBLISH message including status information selected by a publisher and the watcher information set in an additional watcher setting field; and
when the presence service is based on OMA SIMPLE, generating the PUBLISH message by newly defining a content type of the PUBLISH message, setting the status information selected by the publisher in a status field, and setting the watcher information in an additional tuple corresponding to a watcher setting field.

16. The method of claim 12, wherein the step of transmitting the notification message to the second mobile station includes the steps of:
determining whether a corresponding watcher for which the status information is published or updated is approved; and
transmitting the notification message including the status information when the corresponding watcher is approved.

17. The method of claim 12, wherein the step of publishing or updating the status information mapped to the watcher information includes the steps of:
when an OMA SIMPLE-based presence service is provided, adding, by the presence server, an extension field to a resource list server (RLS) and publishing or updating the status information discriminately according to watcher or group.

18. A wireless instant messaging system comprising:
a presence server that publishes or updates a status information corresponding to a watcher information, the status information and the watcher information are included in a PUBLISH message received from a first mobile station, and transmits a notification message including the status information to a second mobile station associated with the watcher information.

19. A method for managing status information in a wireless instant messaging system, comprising the steps of:
checking, by a mobile station, a system for supporting a presence service;
when the presence service is based on OMA IMPS, generating a PUBLISH message including a status information selected by a publisher and a watcher information set in an additional watcher setting field; and
when the presence service is based on OMA SIMPLE, generating the PUBLISH message by newly defining a content type of the PUBLISH message, setting a status information selected by the publisher in a status field, and setting the watcher information in an additional tuple corresponding to a watcher setting field.
